(19) United States
(12) Patent Application Publication
(10) Pub. No.: US 2025/0265292 A1
(43) Pub. Date: Aug. 21, 2025

(54) Training Environmental Model for Premises Monitoring

(71) Applicant: Grov, LLC, Flower Mound, TX (US)

(72) Inventors: Shy Ward, Flower Mound, TX (US); Mark Reimer, Denver, CO (US)

(73) Assignee: Grov, LLC, Flower Mound, TX (US)

(21) Appl. No.: 19/056,649

(22) Filed: Feb. 18, 2025

Related U.S. Application Data
(60) Provisional application No. 63/554,622, filed on Feb. 16, 2024.

(51) Int. Cl. G06F 16/65; G06F 16/683

(52) U.S. Cl. CPC G06F 16/65; G06F 16/683

(57) ABSTRACT

A method of training a sound classification model for a premises monitoring system may include receiving audio data corresponding to a sound detected at a premises. The audio data may be provided to an active instance of a sound classification model, which may generate classification data indicating the sound is unrecognized. The audio data may be provided to a user device, and updated classification data indicating an identity of the sound may be received from the user device. The audio data and the updated classification data may be stored in a data bucket corresponding to the identity of the sound. When the data bucket contains a threshold quantity of user-classified audio data, a new instance of the sound classification model may be generated and retrained using the user-classified audio data. The active instance of the classification model may be replaced with the new instance of the sound classification model.

### CROSS-REFERENCE TO RELATED APPLICATIONS

This application claims the benefit under 35 U.S.C. § 119 (e) of U.S. Provisional Patent Application No. 63/554,622 titled “Training Environmental Model for Premises Monitoring” filed on 16 Feb. 2024, which disclosure is incorporated herein by reference in its entirety.

### TECHNICAL FIELD

This disclosure relates to devices, systems, and methods of premises monitoring, and more specifically to premises monitoring using sound classification models.

### BACKGROUND

Existing premises security systems monitor a premises for predefined events that are typically associated with one or more specialized sensors. For example, a premises security system may trigger an intrusion alarm when a door contact sensor is triggered. Further, these existing premise security systems may have blind spots in that a specialized sensor (e.g., motion sensor, video analytics-based sensor, etc.) may not be able to monitor an entire room due to a limited field of view or range and/or limited detectable characteristics of the event.

Some existing premises security systems may implement a sound sensor for detecting noises (e.g., a breaking window). For example, US Patent Publication No. 2023/0143806 A1 of Reimer, et al., entitled “Premises Monitoring Using Acoustic Models of Premises,” incorporated herein in its entirety by reference, describes a control device that is configured to generate an acoustic model for a particular premises based on a plurality of acoustic samples from the premises and the verification that certain sound anomalies are expected.

### SUMMARY

Various implementations of this disclosure relate to a monitoring device for monitoring a premises. The monitoring device may include a microphone that detects a sound and generates audio data based on the sound. The monitoring device may include a processor that receives the audio data; generates classification data for the audio data, determines whether the sound is recognized, initiates a user alert in response to the sound not being recognized, determines whether the sound is expected, and initiates a premises alert in response to the sound being unexpected.

The classification data may be generated using a classification model. The classification model may be trained to recognize a set of classified sounds. The classification data may indicate an identity of the sound. The classification data may indicate that the sound is not classified in the set of classified sounds. The classification data may be used to determine whether the sound is recognized in the set of classified sounds. If the classification data indicates the sound is not recognized in the set of classified sounds, the user alert may be initiated. The processor may determine whether the classification data indicates the sound is expected based on environment data. The environment data may identify expected sounds of an environment, which may be a type of setting of the premises. The premises alert may be initiated in response to the environment data indicating the sound is unexpected for the environment.

In some implementations, the set of classified sounds may be based on typical sounds encountered in the environment. The environment may include a home environment, an office environment, a work environment, a living environment, a medical environment, a manufacturing environment, a recreation environment, an agricultural environment, a business environment, a natural environment, a travel environment, or a construction environment. The premises may include a home, office, workplace, living space, medical space, manufacturing space, recreational area, agricultural area, business, natural space, travel space, or construction site.

The environment data, in various implementations, may be based on premises data for one or more other premises (i.e., not the premises being monitored) that correspond to the environment. The premises data may indicate whether a sound classification is expected for at least one of the one or more other premises. However, in some implementations, the premises data may also include, or may only include, monitoring data of the premises being monitored.

In some implementations of this disclosure, the processor may receive identification data. The identification data may be received in response to the processor initiating the user alert. The identification data may classify the sound. The processor may update the classification model with the identification data so that the classification model recognizes the sound. In various implementations, the identification data may indicate the sound is expected for the environment or the premises. The processor may update the classification model to recognize the sound as expected.

In some implementations of this disclosure, the processor may receive identification data. The identification data may be received in response to the processor initiating the user alert. The identification data may classify the sound. The processor may update the classification model with the identification data so that the classification model recognizes the sound. In various implementations, the identification data may indicate the sound is expected for the environment or the premises. The processor may update the classification model to recognize the sound as expected.

Various implementations of this disclosure relate to a system for monitoring a premises. The system may include a listening device, a communication device, and a processing device. The listening device may detect a sound that occurs at the premises. The listening device may generate audio data based on the sound. The communication device may communicate the audio data from the listening device to, e.g., the processing device. The processing device may receive the audio data.

The processing device may generate classification data for the audio data using a classification model. The classification model may be trained to recognize a set of classified sounds. The classification data may indicate an identity of the sound. The classification data may indicate that the sound is not classified in the set of classified sounds. The processing device may determine whether the sound is recognized in the set of classified sounds, which determination may be made based on the classification data. In response to the classification data indicating the sound is not recognized, the processing device may initiate a user alert. The user alert may indicate the sound is not recognized in the set of classified sounds. The processing device may determine, based on environment data that identifies expected sounds of an environment, whether the classification data indicates the sound is expected for the environment. In response to the environment data indicating the sound is unexpected for the environment, the processing device may initiate a premises alert.

In various implementations, the set of classified sounds may be based on typical sounds encountered in a plurality of different environments. The environment(s) may include a home environment, an office environment, a work environment, a living environment, a medical environment, a manufacturing environment, a recreation environment, an agricultural environment, a business environment, a natural environment, a travel environment, or a construction environment. The premises may include a home, office, workplace, living space, medical space, manufacturing space, recreational area, agricultural area, business, natural space, travel space, or construction site.

In various implementations, the environment data may be based on premises data for one or more other premises (i.e., not the monitored premises) that correspond to the environment. The premises data may indicate whether a sound classification is expected for at least one of the one or more other premises. However, in some implementations, the premises data may also include, or may only include, monitoring data of the premises being monitored.

In various implementations, the system may include a user device. The user device may be communicatively coupled to the processing device, which may initiate the user alert by transmitting alert data to the user device. The alert data may indicate the sound is not classified. The processing device may receive, from the user device, identification data, which data may classify the sound. The processing device may update the classification model to recognize the sound. In some implementations, the processing device may initiate the user alert or the premises alert by transmitting alert data to the user device. The alert data may indicate the sound is not expected. In response to initiating the user alert or the premises alert, the processing device may receive identification data from the user device that indicates the sound is expected for the environment or the premises. The processing device may update the classification model to recognize the sound as expected.

Various implementations of this disclosure relate to a method of monitoring a premises. The method may include receiving audio data, generating classification data for the audio data, determining whether a sound associated with the audio data is recognized, initiating a user alert if the sound is not recognized, determining whether the sound is expected for a particular environment, and initiating a premises alert if the sound is not expected.

The audio data may correspond to a sound detected at the premises being monitored. The classification data may be generated using a classification model, which may be trained to recognize a set of classified sounds. The classification data may indicate an identity of the sound. The classification data may indicate that the sound is not classified in the set of classified sounds. The classification data may be compared to the set of classified sounds in determining whether the sound is recognized. The user alert may be initiated if the classification data indicates the sound is not recognized in the set of classified sounds. Environment data and/or the classification data may be used to determine whether the sound is expected for the environment. The environment data may identify expected sounds of the environment. If the environment data indicates the sound is unexpected for the environment, the premises alert may be initiated.

In various implementations, the set of classified sounds may be based on typical sounds encountered in the environment. In some implementations, the set of classified sounds may be based on typical sounds encountered in a plurality of different environments.

In various implementations, the environment may be a home environment, an office environment, a work environment, a living environment, a medical environment, a manufacturing environment, a recreation environment, an agricultural environment, a business environment, a natural environment, a travel environment, or a construction environment. The premises may be a home, office, workplace, living space, medical space, manufacturing space, recreational area, agricultural area, business, natural space, travel space, or construction site.

In some implementations, the environment data may be based on premises data for one or more other premises (i.e., not the monitored premises) that correspond to the environment. The premises data may indicate whether a sound classification is expected for at least one of the one or more other premises. However, in some implementations, the premises data may also include, or may only include, monitoring data of the premises being monitored.

In some aspects, the techniques described herein relate to a method of training a sound classification model for a premises monitoring system. The method may include receiving audio data corresponding to a sound detected at a premises, providing the audio data to an active instance of a sound classification model, generating, by the active instance of the sound classification model, classification data that indicates the sound is unrecognized, providing the audio data to a user device associated with a user, receiving, from the user device, updated classification data that indicates an identity of the sound and one or more environments in which the sound is expected or unexpected, storing the audio data and the updated classification data in a data bucket corresponding to the identity of the sound, determining the data bucket contains a threshold quantity of user-classified audio data, generating a new instance of the sound classification model, retraining the new instance of the sound classification model using the user-classified audio data, and replacing the active instance of the classification model with the new instance of the sound classification model.

In various implementations, the method may include determining the identity of the sound is new. A new data bucket may be generated corresponding to the identity of the sound. The audio data and the updated classification data may be stored in the new data bucket.

The method may include, in various implementations, providing test audio data including the sound to the new instance of the sound classification model and determining whether the new instance of the sound classification model correctly identifies the sound. The active instance of the sound classification model may be replaced with the new instance of the sound classification model in response to the new instance of the sound classification model correctly identifying the sound. In various implementations, the test audio data may include a plurality of sound clips of the sound. Determining whether the new instance of the sound classification model correctly identifies the sound may be based on the new instance correctly identifying a threshold number of the plurality of sound clips.

The audio data received in the method may, in some implementations, correspond to the sound and another sound that is recognized by the active instance of the sound classification model. The method may, in such implementation, further including generating second classification data that indicates an identity of the other sound. The method may further include determining, based on environment data that identifies expected sounds of an environment, whether the second classification data indicates that the other sound is expected for an environment associated with the premises. In response to the environment data indicating the sound is unexpected for the environment associated with the premises, the method may include initiating a premises alert.

In various implementations, the method may include generating and transmitting a notification to the user that indicates the sound indicated by the audio data is unrecognized.

Another method of training a sound classification model for a premises monitoring system may include: receiving first audio data corresponding to a first instance of a sound, the first instance of the sound detected at a premises; providing the first audio data to an active instance of a sound classification model; generating, by the active instance of the sound classification model, first classification data that indicates the sound is unrecognized; providing the audio data to a user device associated with a user; receiving, from the user device, updated classification data that indicates an identity of the sound; storing the first audio data and the updated classification data in a data bucket corresponding to the identity of the sound; determining the data bucket contains a threshold quantity of user-classified audio data for the sound; generating a new instance of the classification model; retraining the new instance of the classification model using the user-classified audio data; replacing the active instance of the classification model with the new instance of the classification model; receiving second audio data corresponding to a second instance of the sound; providing the second audio data to the new instance of the sound classification model; generating, by the new instance of the sound classification model, second classification data that indicates the identity of the sound; determining, based on environment data that identifies expected sounds of an environment associated with the premises, whether the sound is expected for the environment; and initiating a premises alert in response to the environment data indicating the sound is unexpected for the environment.

In various implementations, the method may further include determining the identity of the sound is new. A new data bucket may be generated corresponding to the identity of the sound. The audio data and the updated classification data may be stored in the new data bucket.

The method may, in various implementations, include validating an accuracy of the new instance of the sound classification model. In some implementations, such validation may include providing test audio data that includes the sound to the new instance of the sound classification model and determining whether the new instance of the sound classification model correctly identifies the sound. The active instance of the sound classification model may be replaced with the new instance of the sound classification model in response to the new instance of the sound classification model correctly identifying the sound. The test audio data may, in some implementations, include a plurality of sound clips of the sound. Determining whether the new instance of the sound classification model correctly identifies the sound may be based on the new instance correctly identifying a threshold number of the plurality of sound clips.

In various implementations, the first audio data may correspond to the sound and another sound. The other sound may be recognized by the active instance of the sound classification model. The method may include generating second classification data that indicates an identity of the other sound. Based on the environment data, it may be determined whether the second classification data indicates that the other sound is expected for the environment. The method may include initiating a premises alert in response to the environment data indicating the sound is unexpected for the environment.

In some aspects, the method may include generating and transmitting a notification to the user that indicates the sound is unrecognized.

In some aspects, the techniques described herein relate to a premises monitoring system. The system may include a listening device, a communication device, and one or more control devices. The listening device may detect a sound and generate audio data based on the sound. The communication device may communicate the audio data from the listening device, e.g., to the control device. The control device may execute one or more functions that: receive the audio data; provide the audio data to an active instance of a sound classification model; generate, by the active instance of the sound classification model, classification data that indicates the sound is unrecognized; provide the audio data to a user device associated with a user; receive, from the user device, updated classification data that indicates an identity of the sound and one or more environments in which the sound is expected or unexpected; store the audio data and the updated classification data in a data bucket corresponding to the identity of the sound; determine the data bucket contains a threshold quantity of user-classified audio data; generate a new instance of the classification model; retrain the new instance of the classification model using the user-classified audio data; and replace the active instance of the classification model with the new instance of the classification model.

In some aspects, the one or more control devices may determine the identity of the sound is new, generate a new data bucket corresponding to the identity of the sound, and store the audio data and the updated classification data in the new data bucket.

In some aspects, the one or more control devices may provide test audio data including the sound to the new instance of the sound classification model and determine whether the new instance of the sound classification model correctly identifies the sound. In various implementations, the active instance of the sound classification model may be replaced with the new instance of the sound classification model in response to the new instance of the sound classification model correctly identifying the sound. In some aspects, the test audio data may include a plurality of sound clips of the sound. Determining whether the new instance of the sound classification model correctly identifies the sound may be based on the new instance correctly identifying a threshold number of the plurality of sound clips.

In some aspects, the audio data may correspond to the sound and another sound that is recognized by the active instance of the sound classification model. The one or more control devices may, in various implementations, generate second classification data that indicates an identity of the other sound. The one or more control devices may determine, based on environment data that identifies expected sounds of an environment, whether the second classification data indicates that the other sound is expected for an environment associated with the premises. A premises alert may be initiated in response to the environment data indicating the sound is unexpected for the environment associated with the premises.

In some aspects, the method may include generating and transmitting a notification to the user that indicates the sound is unrecognized.

Further aspects and embodiments are provided in the foregoing drawings, detailed description, and claims.

### BRIEF DESCRIPTION OF THE DRAWINGS

The present description will be understood more fully when viewed in conjunction with the accompanying drawings of various examples of premises monitoring based on an environment model. The description is not meant to limit the premises monitoring to specific examples. Rather, the specific examples depicted and described are provided for explanation and understanding of premises monitoring based on an environment model. Throughout the description the drawings may be referred to as drawings, figures, and/or FIGs.

FIG. 1 illustrates a premises monitoring system, according to an implementation.

FIG. 2 illustrates a new sound classification system, according to some implementations.

FIG. 3 illustrates a cloud-based premises monitoring system, according to an implementation.

FIG. 4 illustrates a system diagram of a monitoring device, according to an implementation.

FIG. 5 illustrates a system diagram of a premises monitoring system, according to an implementation.

FIG. 6 illustrates a method of monitoring a premises, according to an implementation.

FIG. 7 illustrates a method of classifying unrecognized sounds, according to an implementation.

FIG. 8 illustrates a method of updating an expectation status of a sound, according to an implementation.

FIG. 9, FIG. 10, and FIG. 11 illustrate an example system architecture of the various systems and methods disclosed herein.

FIG. 12 illustrates a method of training a sound classification model for a premises monitoring system, according to various implementations.

FIG. 13 illustrates a method of deploying a retrained sound classification model in a premises monitoring system, according to various implementations.

FIG. 14 illustrates a method of categorizing previously undetected sounds, according to various implementations.

FIG. 15 illustrates a method of validating an accuracy of a retrained instance of a sound classification model, according to various implementations.

FIG. 16 illustrates a method of handling audio data that corresponds to multiple sounds, according to various implementations.

### DETAILED DESCRIPTION

Premises monitoring as disclosed herein will become better understood through a review of the following detailed description in conjunction with the figures. The detailed description and figures provide merely examples of the various implementations of premises monitoring based on an environment model. Many variations are contemplated for different applications and design considerations; however, for the sake of brevity and clarity, all the contemplated variations may not be individually described in the following detailed description. Those skilled in the art will understand how the disclosed examples may be varied, modified, and altered and not depart in substance from the scope of the examples described herein.

Various aspects of the systems, devices, and/or methods disclosed herein may be referred to as “data.” Data may be used to refer generically to modes of storing and/or conveying information. Accordingly, data may refer to textual entries in a table of a database. Data may refer to alphanumeric characters stored in a database. Data may refer to machine-readable code. Data may refer to images. Data may refer to audio. Data may refer to, more broadly, a sequence of one or more symbols. The symbols may be binary. Data may refer to a machine state that is computer-readable. Data may refer to human-readable text.

The methods disclosed herein may be implemented in a variety of ways using any of a variety of devices, systems, components, and subprocesses. In various implementations, the methods described herein may be implemented using one or more of the devices and/or systems described herein. In various implementations, the methods described herein may be implemented using at least a portion of the systems described herein. Two or more of the methods described herein may be implemented together. Portions of one method may be implemented in another method.

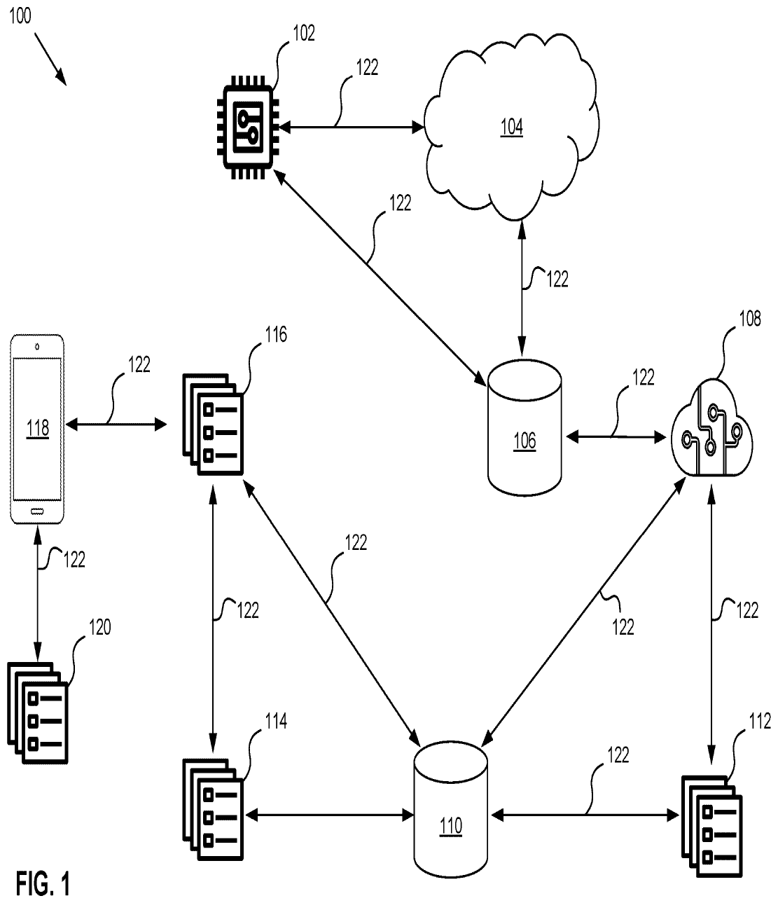

FIG. 1 illustrates a premises monitoring system 100, according to an implementation. The premises monitoring system 100 may include a monitoring device 102, a device management service 104, an audio database 106, a classification service 108, a classified audio database 110, a new sound service 112, a classification filter 114, a notification service 116, a user device 118, and an authentication service 120. Various elements of the premises monitoring system 100 may communicate via one or more communication links 122.

The monitoring device 102 may include a microphone and a communication device such as a transmitter or transceiver. The listening device may detect sound and/or generate audio data based on the sound. The monitoring device 102 may include a variety of other sensors related to premises monitoring. The monitoring device 102 may include one or more types of sensors, control, and/or image capture devices. For example, the types of sensors may include various safety related sensors such as motion sensors, fire sensors, carbon monoxide sensors, flooding sensors, contact sensors, sound sensors (e.g., sound detectors), among other sensor types. For example, the sound sensors may include glass break sensors for detecting the sound of breaking glass, break-in sensors for detecting sounds above a predefined threshold such as a door breach, etc. The monitoring device 102 may include one or more lights for illuminating a monitored area.

The monitoring device 102 may be connected to one or more other devices and/or services. For example, as depicted, the monitoring device 102 may communicate data with the device management service 104. The monitoring device 102 may be an IoT (internet of things) device. In some implementations, at least a portion of the device management service 104 may be implemented on the monitoring device 102, such as via memory and processing controls of the monitoring device 102. In some implementations, at least a portion of the device management service 104 may be implemented on another device or system, such as a cloud computing system, an on-premises computing system (e.g., a device, server, or computer located on the monitored premises), or a private computing system (e.g., a system physically at another location but owned or controlled directly by the party monitoring the premises). The device management service 104 may, for example, be implemented in a serverless cloud computing environment. The device management service 104 may receive data such as device information and/or function requests from the monitoring device 102. The device management service 104 may execute one or more functions, such as by generating and/or publishing a uniform resource locator (URL) for the monitoring device 102. The device management service 104 may communicate information back to the monitoring device 102, such as connection and/or subscription data.

The monitoring device 102 may be connected to and/or communicate with the audio database 106. At least a portion of the audio database 106 may, in some implementations, be implemented on the monitoring device 102, such as in memory of the monitoring device 102. In some implementations, at least a portion of the audio database 106 may be implemented on another device or system, such as a cloud computing system, an on-premises computing system (e.g., a device, server, or computer located on the monitored premises), or a private computing system (e.g., a system physically at another location but owned or controlled directly by the party monitoring the premises). The audio database 106 may store audio data generated by the monitoring device 102 and communicated from the monitoring device 102 to the audio database 106, such as via the one or more communication links 122.

The device management service 104 may communicate with the audio database 106, such as by providing device identification data to the audio database 106 for the monitoring device 102. In various implementations, the premises monitoring system 100 may include several listening devices and/or other security devices. The device management service 104 may manage some or all of the security devices of the premises monitoring system 100. The device management service 104 may manage two or more security devices for the same premises, or multiple security devices at different premises. The audio database 106 may store data for two or more listening devices. The audio database 106 may store data for multiple listening devices on the same premises or on different premises. In some implementations, the audio database 106 may be an event database that stores other event data such as visual data, motion data, temperature data, etc.

The audio database 106 may communicate with the classification service 108, which may classify data in the audio database 106, such as audio data. The classification service 108 may classify other data where the premises monitoring system 100 includes an event database. The classification service 108 may include a classification model that is trained to recognize event data and/or generate classification data. The classification model may be trained to recognize a set of classified events. The event data may be input into the classification model. The classification model, may in response, output the classification data. The classification data may indicate an identity of the event. The classification data may indicate that the event data is not recognized.

In some implementations, the classification model may be trained to recognize a set of classified sounds. The set of classified sounds may be based on typical sounds encountered in two or more, or a plurality, of different environments. Audio data may be communicated from the audio database 106 to the classification service 108. The audio data may be input into the classification model. The classification model may output classification data associated with the audio data. The classification data may indicate an identity of a sound indicated by the audio data. The classification data may indicate the sound is not classified in the set of sounds on which the classification model is trained.

As used herein, “model” may refer to one or more sets of computer-readable instructions based on one or more sets of data and/or one or more artificial intelligence or machine learning models. The models may include, for example, a machine learning model, an artificial neural network model, a deep learning model, a linear regression model, a logistic regression model, a decision tree model, a random forest model, a Bayes model, a naïve Bayes model, a k-nearest neighbor model, a linear discriminant analysis model, a natural language processing model, a sentiment analysis model, or a general intelligence model.

A classification model as disclosed herein may be trained to have general intelligence or may be trained with specific intelligence. The classification model may operate by receiving data, processing the data, and generating other data. The generated data may be generated in response to the receipt and processing of the initial data. Processing may include making various determinations based on training of the model. In general, a “determination” refers to any process or set of processes by which the model decides how to handle data provided to it. “Determination” may also refer to generating output data as a result of processing input data. For example, the classification model may determine that an input is an audio input based on one or more characteristics of the input, e.g., metadata. The classification model may process the audio input using a sound classification model such as YAMNet and output data indicative of one or more characteristics of the input. The output may be used as an input for another portion of the model to make further determinations regarding the input. Multiple inputs to the classification model may be combined in making a determination. The classification model may process metadata of the communication separately from content data, e.g., by using different data processing models, and may combine the outputs of those models to make further determinations and/or generate other data.

The classification service 108 may communicate the classification data with the classified audio database 110 and/or the new sound service 112. For example, in response to the classification data indicating a classification of particular audio data, the classification service 108 may push the audio data and/or the classification data to the classified audio database 110. As another example, in response to the classification data indicating the sound associated with the audio data is not recognized, the classification service 108 may push the audio data to the new sound service 112. The new sound service 112 may notify a user that the sound associated with the audio data is not classified. For example, the new sound service 112 may initiate a user alert in response to the classification data indicating the sound is not recognized in the set of classified sounds. The new sound service 112 may receive identification data classifying the sound. The new sound service 112 may provide the identification data and/or the audio data to the classified audio database 110. The new sound service 112 may provide the identification data and/or the audio data to the classification service 108. The classification service 108 may update the classification model based at least in part on the identification data.

The classified audio database 110 may store the audio data and associated classification data. The classified audio database 110 may communicate with the classification filter 114, such as providing the audio data and/or the classification data to the classification filter 114. The classification filter 114 may determine whether to initiate a premises alert based on the audio data and/or the classification data. In various implementations, the classification filter 114 may use environment data to determine whether a particular sound is expected for a particular environment. The environment data may identify the expected sounds of a particular environment. For example, the set of classified sounds recognized by the classification model may be based on typical sounds encountered in the environment. The environment data may identify a subset of the set of classified sounds that is expected, and/or a subset that is not expected. As another example, the set of classified sounds recognized by the classification model may be agnostic regarding the environment. The environment data may identify a subset of the classified sounds that is expected for the environment, and/or a subset that is not expected.

The environment data may be associated with a specific environment, e.g., a type of setting of the premises being monitored. For example, the environment may include a home environment, an office environment, a work environment, a living environment, a medical environment, a manufacturing environment, a recreation environment, an agricultural environment, a business environment, a natural environment, a travel environment, or a construction environment, and so forth. In turn, the premises may be in a specific location characterized by the environment. For example, the premises may include a home, office, workplace, living space, medical space, manufacturing space, recreational area, agricultural area, business, natural space, travel space, or construction site, and so forth.

In general, different environments may have different typical sound profiles. For example, different sounds may be expected and/or unexpected in a home environment as compared to a manufacturing environment. A sound that is typical for the manufacturing environment may be cause for alarm in the home environment. The environment data may reflect these differences. During setup of the premises monitoring system 100, the user may set the classification filter 114 such that the environment data indicates a particular environment.

The environment data may identify the environment without identifying the particular premises. For example, the environment data may be based on premises data for one or more other premises (e.g., not including, or in addition to, the premises being monitored) that correspond to the environment. The premises data may indicate whether a sound classification is expected for at least one of the one or more other premises.

The audio data and/or the classification data may indicate the premises and/or the environment of the premises. For example, the audio data may indicate the premises is associated with a particular physical address, IP (internet protocol) address, monitoring device, and/or user. In various implementations, the environment data may identify the environment and the particular premises. For example, the environment data may indicate a home associated with a particular user, where the home is in an agricultural environment. In some implementations, the environment data may identify two or more environments. For example, the environment data may indicate a home environment and a construction environment, such as when a home is undergoing renovations. In various implementations, the environment data may be augmented for a particular use case by a user. For example, the environment data may indicate a medical environment. The classification filter 114 may be initially set to initiate an alert or notification when shouting or yelling is indicated in the audio data. The premises may be a medical facility where patients shouting or yelling are common. The user may augment the classification filter 114 so that an alert or notification is not triggered when shouting or yelling is indicated in the audio data.

The classification filter 114 may identify sounds not recognized by the classification model. In various implementations, the classification filter 114 may be set by a user to notify the user when an unrecognized sound is detected as indicated by the audio data and/or the classification data.

The classification filter 114 may communicate data with the notification service 116. For example, the classification filter 114 may communicate the audio data and/or the classification data to the notification service 116 in response to the environment data indicating the sound associated with the audio data is unexpected for the environment. As another example, the classification filter 114 may communicate the audio data and/or the classification data to the notification service 116 in response to the classification data indicating the sound associated with the audio data was not recognized by the classification model. The notification service 116 may initiate a premises alert as prompted by the classification filter 114. In various embodiments, the notification service 116 may push a notification to the user device 118, such as via the one or more communication links 122. The notification service 116 may communicate the audio data and/or the classification data to the user device 118.

The user device 118 may be a user-oriented computing device such as a smartphone, a personal computer, a tablet computer, and so forth. In general, the user device 118 may, without limitation, include such elements as a user interface, a memory, a processor, various sensors, a locator, and one or more communication devices. The user device 118 may receive data via the notification service 116 such as alert data, notification data, audio data, environment data, classification data, and so forth. The notification service 116 may, in various implementations, be implemented via an application server that communicates data to, and receives data from, user device 118. The user device 118 may communicate data with various elements of the premises monitoring system via the application server, such as the classification filter 114, the classified audio database 110, the audio database 106, the monitoring device 102, and so forth. The authentication service 120 may authenticate the user device 118 and/or identify permissions associated with the user device 118, such as permission to update the classification filter 114, retrieve, modify, or delete audio data, update the classification model, create or change settings for the monitoring device 102, and so forth.

In various implementations, the classification filter 114 may initiate a premises alert based on the environmental data and/or the classification data indicating the sound associated with the audio data is not expected for the environment and/or the premises. The alert may be communicated to the user device 118 via the notification service 116. In response, the classification filter 114 and/or the classification service 108 may receive, from the user device 118, identification data that indicates the sound is expected for the environment or the premises. The classification filter 114 and/or the classification model may be updated to recognize the sound as expected.

In various implementations, audio data and/or classification data that is not associated with an alert or notification may be communicated to the user device 118. The sound associated with the audio data may be classified as expected for the environment. The classification service 108 and/or the classification filter 114 may receive, from the user device 118, identification data that indicates the sound is not expected for the environment or the premises. The classification filter 114 and/or the classification model may be updated to recognize the sound as unexpected.

One or more of the services described herein, including the classification service 108, the new sound service 112, the classification filter 114, the notification service 116, and/or the authentication service 120, may be implemented as executable code that is executable by one or more processors or processing devices associated with the premises monitoring system 100. Such services may be implemented, for example, in a cloud computing environment. An advantage of the premises monitoring system 100 may be that it can be rapidly deployed, and effective, for a variety of different monitoring devices 102 in different environments and located at different premises without requiring specific training for specific premises.

Various aspects of the premises monitoring system 100 may be web-based. For example, the user device 118 may access the various services and/or data stores associated with the premises monitoring system 100 via an online portal. The services and/or data stores may be implemented via one or more server devices. The premises monitoring system 100 may be implemented using a public internet. The premises monitoring system 100 may be implemented using a private intranet. Elements of the premises monitoring system 100 may be physically housed at a location remote from an entity that owns and/or operates the premises monitoring system 100. For example, various elements of the premises monitoring system 100 may be implemented on servers that are physically housed at a public service provider such as a web services provider. Elements of the premises monitoring system 100 may be implemented on servers that are physically housed at a private location, such as a location occupied by the entity that owns and/or operates the premises monitoring system 100.

The server may include a physical server and/or a virtual server. For example, the server may include one or more bare-metal servers. The bare-metal servers may be single-tenant servers or multiple tenant servers. In another example, the server may include a bare metal server partitioned into two or more virtual servers. The virtual servers may include separate operating systems and/or applications from each other. In yet another example, the server may include a virtual server distributed on a cluster of networked physical servers. The virtual servers may include an operating system and/or one or more applications installed on the virtual server and distributed across the cluster of networked physical servers. In yet another example, the server may include more than one virtual server distributed across a cluster of networked physical servers.

The term “server” may refer to functionality of a device and/or an application operating on a device. For example, an application server may be programming instantiated in an operating system installed on a memory device and run by a processing device. The application server may include instructions for receiving, retrieving, storing, outputting, and/or processing data. A processing server may be programming instantiated in an operating system that receives data, applies rules to data, makes inferences about the data, and so forth. Servers referred to separately herein may be instantiated in the same operating system and/or on the same device. Separate servers may be instantiated in the same application or in different applications.

Various of the devices disclosed herein, including the user device 118, and/or the monitoring device 102, may include a user interface for outputting information in a format perceptible by a user, and receiving input from the user. The user interface may include a display screen such as a light-emitting diode (LED) display, an organic LED (OLED) display, an active-matrix OLED (AMOLED) display, a liquid crystal display (LCD), a thin-film transistor (TFT) LCD, a plasma display, a quantum dot (QLED) display, and so forth. The user interface may include an acoustic element such as a speaker, a microphone, and so forth. The user interface may include a button, a switch, a keyboard, a touch-sensitive surface, a touchscreen, a camera, a fingerprint scanner, and so forth. The touchscreen may include a resistive touchscreen, a capacitive touchscreen, and so forth.

Various of the systems and devices described herein, including the monitoring device 102, the user device 118, and/or the computing system(s) that implements the services and data stores, may include one or more processors. Such processors may have volatile and/or persistent memory. The processors may generate an output based on an input. For example, the processors may receive an electronic and/or digital signal. The processors may read the signal and perform one or more tasks with the signal, such as performing various functions with data in response to input received by the processors. The processors may read from memory information needed to perform various functions, such as method steps disclosed herein. The processors may send an output signal to memory, and the memory may store data according to the signal output by the processors.

The processors may be and/or include a processor, a microprocessor, a computer processing unit (CPU), a graphics processing unit (GPU), a neural processing unit, a physics processing unit, a digital signal processor, an image signal processor, a synergistic processing element, a field-programmable gate array (FPGA), a sound chip, a multi-core processor, and so forth. As used herein, “processor,” “processing component,” “processing device,” and/or “processing unit” may be used generically to refer to any or all of the aforementioned specific devices, elements, and/or features of the processors.

Various of the systems and devices described herein, including the monitoring device 102, the user device 118, and/or the computing system(s) that implements the services and data stores, may include memory. The memory may have volatile and/or persistent memory. The memory may be and/or include a computer processing unit register, a cache memory, a magnetic disk, an optical disk, a solid-state drive, and so forth. The memory may be configured with random access memory (RAM), read-only memory (ROM), static RAM, dynamic RAM, masked ROM, programmable ROM, erasable and programmable ROM, electrically erasable and programmable ROM, and so forth. As used herein, “memory,” “memory component,” “memory device,” and/or “memory unit” may be used generically to refer to any or all of the aforementioned specific devices, elements, and/or features of the memory.

Various of the systems and devices described herein, including the monitoring device 102, the user device 118, and/or the computing system(s) that implements the services and data stores, may include one or more communicators. The communicators may include, for example, a networking chip, one or more antennas, and/or one or more communication ports. The communicators may generate radio frequency (RF) signals and transmit the RF signals via one or more of the antennas. The communicators may receive and/or translate the RF signals. The communicators may transceive the RF signals. The RF signals may be broadcast and/or received by the antennas. In various implementations, the communicators may include communication means implemented in an integrated circuit and/or communications means within a device between different integrated circuits.

The communicators may generate electronic signals and transmit the RF signals via one or more of the communication ports. The communicators may receive the RF signals from one or more of the communication ports. The electronic signals may be transmitted to and/or from a communication hardline by the communication ports. The communicators may generate optical signals and transmit the optical signals to one or more of the communication ports. The communicators may receive the optical signals and/or may generate one or more digital signals based on the optical signals. The optical signals may be transmitted to and/or received from a communication hardline by the communication port, and/or the optical signals may be transmitted and/or received across open space by the networking device.

The communicators may include hardware and/or software for generating and communicating signals over a direct and/or indirect network communication link. For example, the communicators may include a USB port and a USB wire, and/or an RF antenna with Bluetooth programming installed on a processor, such as the processing component, coupled to the antenna. In another example, the communicators may include an RF antenna and programming installed on a processor, such as the processing device, for communicating over a Wi-Fi and/or cellular network. As used herein, “communicator,” “communication device” “communication component,” and/or “communication unit” may be used generically herein to refer to any or all of the aforementioned elements and/or features of the communicators.

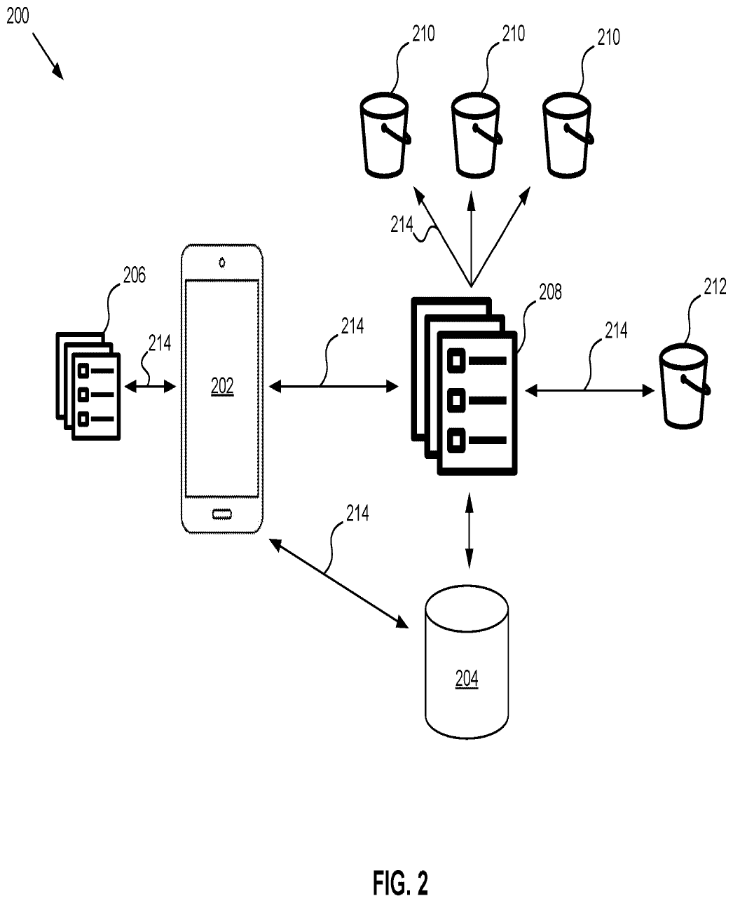

FIG. 2 illustrates a new sound classification system 200, according to some implementations. The new sound classification system 200 may include a user device 202, an audio database 204, an authentication service 206, a classification service 208, a classified sound bucket 210, an unclassified sound bucket 212, and one or more communications links 214. The elements of the new sound classification system 200 may communicate via the one or more communications links 214.

As used herein, “new sound” may refer to sound that is not recognized by the classification model. In various implementations, the monitoring device, e.g., monitoring device 102, may detect sound and generate audio data that is not recognized by the classification model, e.g., as implemented by the classification service 108. This may be due to the quality of the audio data. In some cases, it may be due to the classification model not being trained to recognize the detected sound.

In various implementations, the audio data may be tagged, such as in associated classification data, as unrecognized. The audio data may be passed to the new sound classification system, which may be associated with or in communication with a new sound service, e.g., new sound service 112. In various implementations, the audio data may be stored in the unclassified sound bucket 212, which may, for example, be the audio database 106. The new sound service may include a notification service that notifies a user via user device 202 that an unclassified sound was detected. The authentication service 206 may verify the user associated with the user device 202 has permissions to classify sound.

The user may provide a classification for the sound, which may be pushed from the user device 202 to the classification service 208. The classification service 208 may attach additional classification data to the audio data or may update classification data already associated with the audio data. The classification service 208 may push the audio data to a data store, e.g., classified sound bucket 210, associated with the classification provided by the user. In some implementations, the classification provided by the user may be a new classification for which there is no classified sound bucket 210. The classification service 208 may create a new classified sound bucket 210 for the new classification.

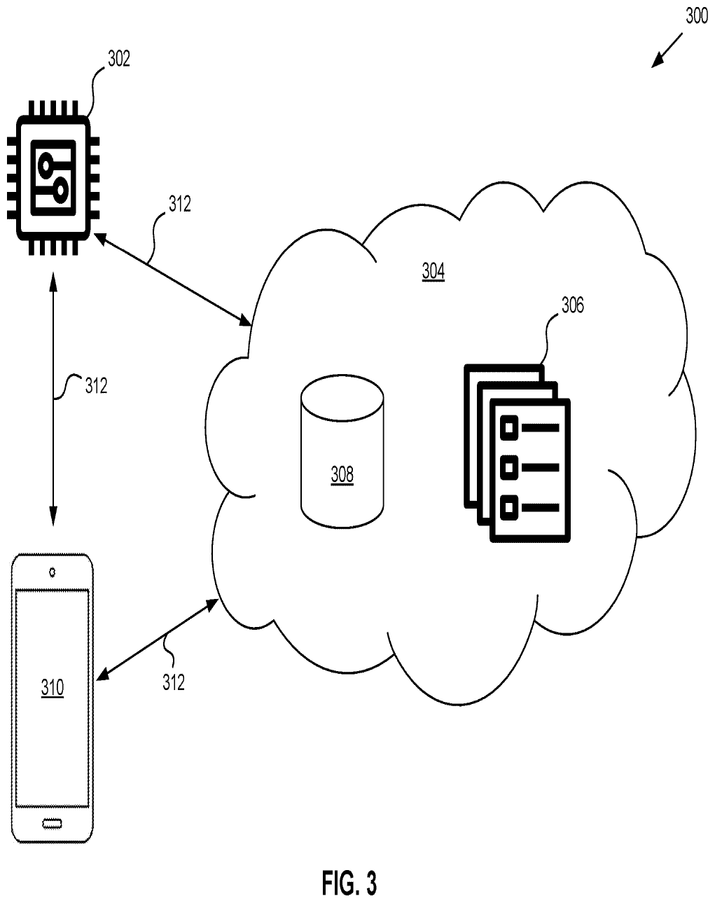

FIG. 3 illustrates a cloud-based premises monitoring system 300, according to an implementation. The cloud-based premises monitoring system 300 may include a monitoring device 302, a cloud architecture 304 in which is implemented one or more services 306 and one or more data stores 308, and a user device 310. The monitoring device 302, cloud architecture 304, and/or the user device 310 may communicate with each other via one or more communication links 312. In various implementations, the premises monitoring system 100 may be implemented as the cloud-based premises monitoring system 300.

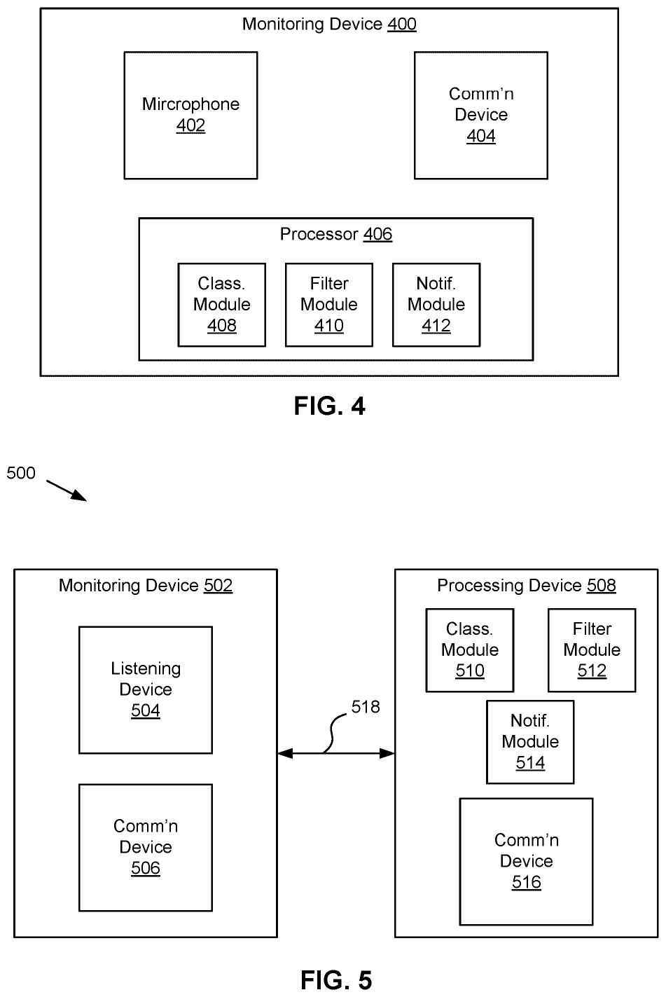

FIG. 4 illustrates a system diagram of a monitoring device 400, according to an implementation. The monitoring device 400 may be placed on a premises and may monitor the premises for various sounds of interest to a user. The monitoring device 400 may include a microphone 402, a communication device 404, and a processor 406. The processor 406 may include various modules for executing various functions, including a classification module 408, a filter module 410, and/or a notification module 412. As used herein, “module” may refer to instructions and/or circuitry configured to execute the tasks associated with the module. Such instructions may be stored by and executable through various combinations of processors and memory. For example, processor 406 may include memory that stores instructions associated with the classification module 408, filter module 410, and/or notification module 412.

The microphone 402 may detect a sound. The microphone may generate audio data based on the sound. The microphone 402 may communicate the audio to the processor 406, such as via internal circuitry of the monitoring device 400. The processor 406 may receive the audio data. A classification model, such as described above regarding the classification service 108, may be implemented in the classification module 408. The classification module 408 may generate classification data for the audio data using the classification module. The classification data may indicate an identity of the sound. The classification data may indicate that the sound is unrecognized.

The processor 406 may determine whether the sound is recognized based on the classification data. Such determination may be made, for example, by the classification module 408 and/or the filter module 410. In response to the sound not being recognized, the processor 406 may initiate a user alert, such as via the notification module 412. The monitoring device 400 may communicate the alert via the communication device 404. For example, the alert may be a notification sent to a user device. The alert may be a sound generated by the communication device 404. The alert may be a light generated by the communication device 404. The alert may include a combination of light and sound.

The processor 406 may determine whether the sound is expected. For example, the classification data may indicate an identity of the sound. Environment data associated with the filter module 410 may identify expected sounds of an environment of the premises being monitored by the monitoring device 400. The processor 406 may determine, such as by the filter module 410, whether the classification data indicates the sound is expected for the environment. In response to the sound not being recognized, the processor 406 may initiate a premises alert, such as via the notification module 412. The monitoring device 400 may communicate the alert via the communication device 404. For example, the alert may be a notification sent to a user device. The alert may be a sound generated by the communication device 404. The alert may be a light generated by the communication device 404. The alert may include a combination of light and sound.

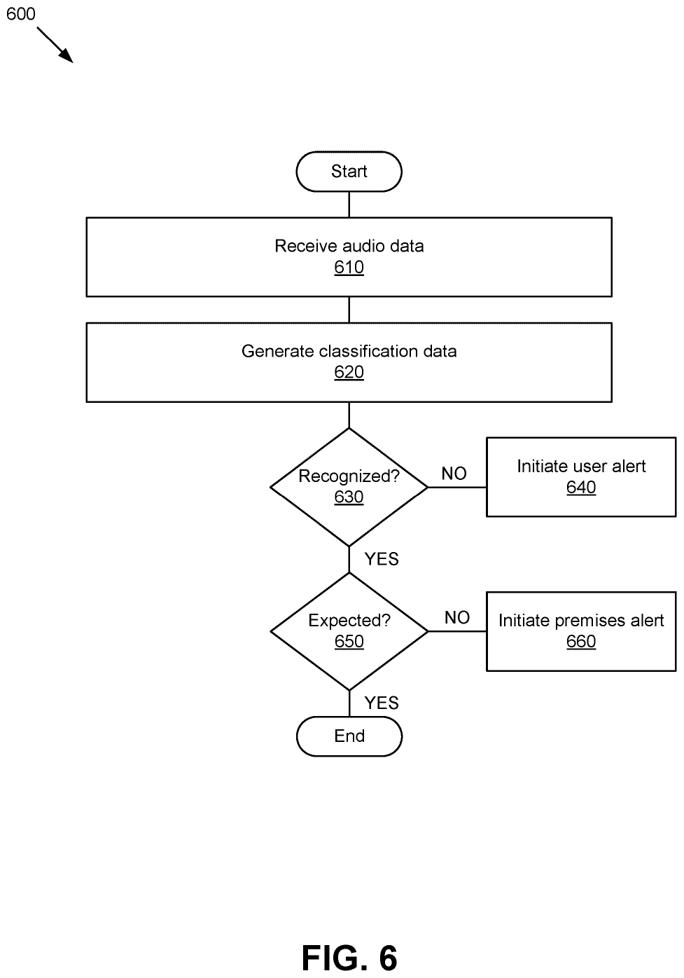

FIG. 5 illustrates a system diagram of a premises monitoring system 500, according to an implementation. The premises monitoring system 500 may include a monitoring device 502 having a listening device 504 and a communication device 506, and a processing device 508 having a classification module 510, a filter module 512, a notification module 514, and a communication device 516. The monitoring device 502 and processing device 508 may communicate via a communication link 518.

The listening device 504 may detect a sound and generate audio data based on the sound. The audio data may be communicated from the monitoring device 502 to the processing device 508 via the communication device 506 and/or the communication device 516. The processing device 508 may receive the audio data and generate classification data for the audio data using a classification model, such as the model described regarding the classification service 108. The classification data may be generated by the classification module 510.

The processing device 508 may determine whether the sound is classified, such as by the classification module 510 and/or the filter module 512. In response to the sound being unrecognized, the processing device 508 may initiate a user alert indicating the sound is not classified. The user alert may be initiated via the notification module 514. The user alert may be communicated via the communication device 516. The user alert may be communicated to a user device of a user with system permission to classify the sound.

The processing device 508 may determine whether the sound is expected. For example, the filter module 512 may include environment data that identifies expected sounds of an environment associated with the premises being monitored. In response to the sound being unexpected, the processing device 508 may initiate a premises alert. The premises alert may be initiated via the notification module 514. The premises alert may be communicated via the communication device 516. The premises alert may include one or more of a sound alert, a light alert, and/or a user notification sent to a user device associated with the premises monitoring system 500.

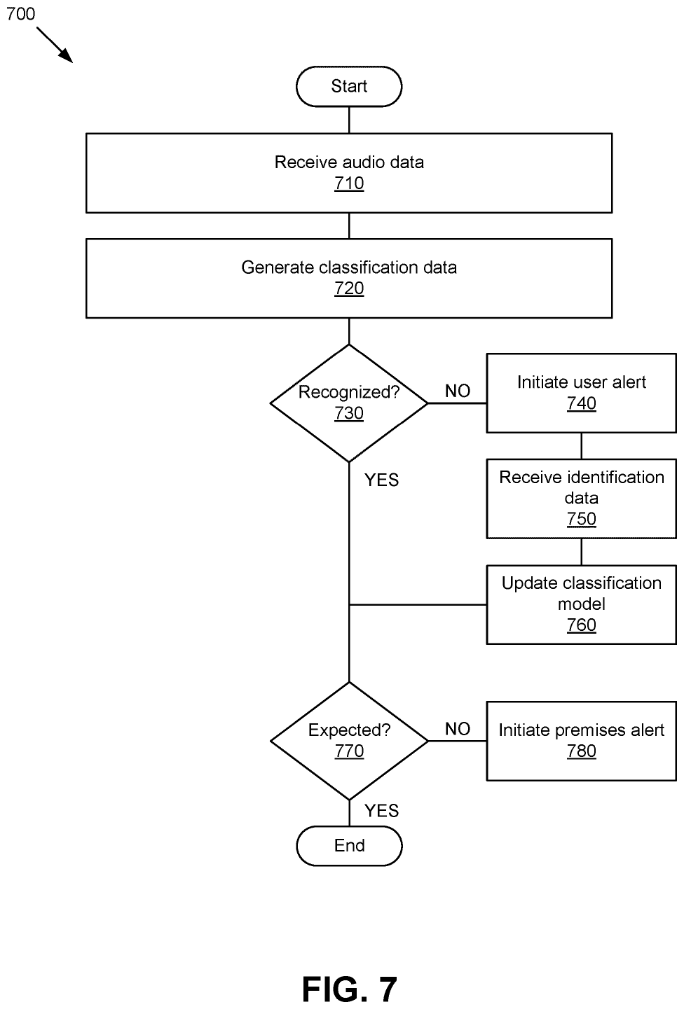

FIG. 6 illustrates a method 600 of monitoring a premises, according to an implementation. The method 600 may include receiving audio data corresponding to a sound detected at the premises (block 610). The method 600 may include generating classification data for the audio data using a classification model (block 620). The classification model may be trained to recognize a set of classified sounds. The classification data may indicate an identity of the sound. The classification data may indicate that the sound is not classified in the set of classified sounds. The classification data may, in various implementations, indicate whether the sound is expected for an environment associated with the premises. For example, the classification data may include one or more environment tags that indicate one or more environments in which the sound is expected.

The method 600 may include determining, based on the classification data, whether the sound is recognized in the set of classified sounds (block 630). In response to the classification data indicating the sound is not recognized, the method 600 may include initiating a user alert (block 640). The method 600 may include determining, based on environment data, whether the classification data indicates the sound is expected for the environment (block 650). The environment data may identify expected sounds of an environment. In response to the environment data indicating the sound is unexpected, the method 600 may include initiating a premises alert (block 660).

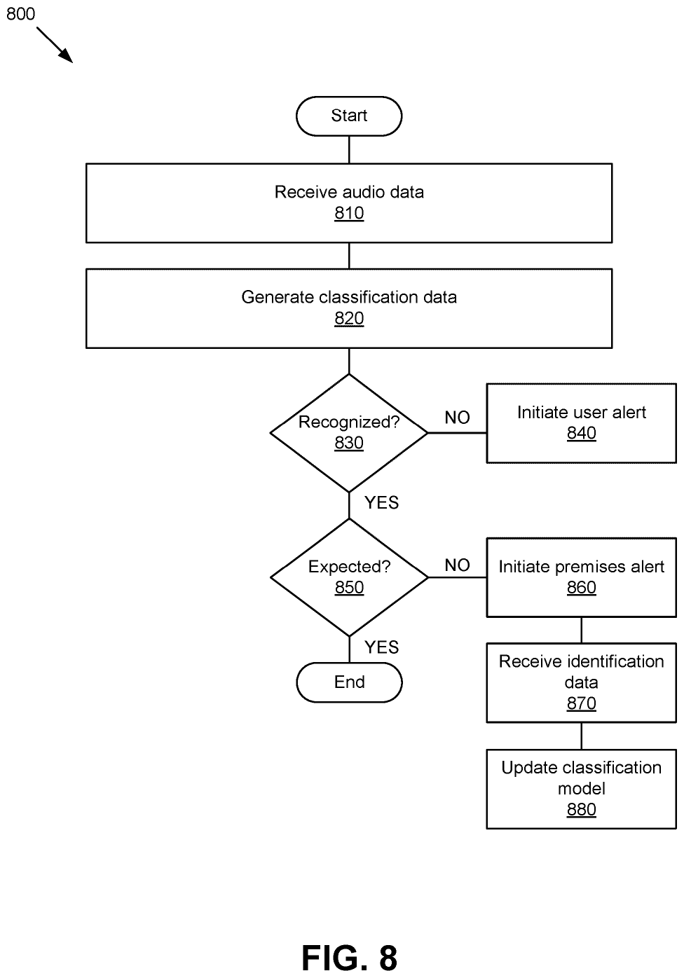

FIG. 7 illustrates a method 700 of classifying unrecognized sounds, according to an implementation. The method 700 may include receiving audio data corresponding to a sound detected at the premises (block 710). The method 700 may include generating classification data for the audio data using a classification model (block 720). The method 700 may include determining, based on the classification data, whether the sound is recognized in the set of classified sounds (block 730). In response to the classification data indicating the sound is not recognized, the method 700 may include initiating a user alert (block 740). In various implementations, the user alert may be initiated by transmitting alert data to a user device. The alert data may indicate the sound is not classified. The method 700 may include receiving, from the user device, identification data that classifies the sound (block 750). The method 700 may include updating the classification model to recognize the sound (block 760).

The method 700 may include determining, based on environment data, whether the classification data indicates the sound is expected for the environment (block 770). In response to the environment data indicating the sound is unexpected, the method 700 may include initiating a premises alert (block 780).

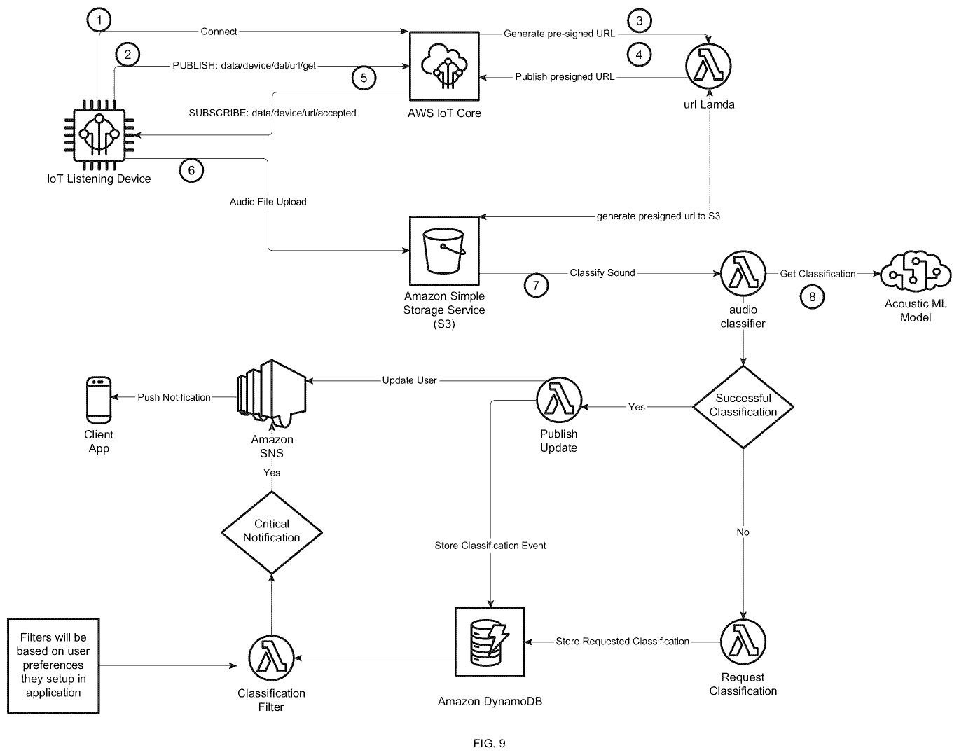

FIG. 8 illustrates a method 800 of updating an expectation status of a sound, according to an implementation. The method 800 may include receiving audio data corresponding to a sound detected at the premises (block 810). The method 800 may include generating classification data for the audio data using a classification model (block 820). The method 800 may include determining, based on the classification data, whether the sound is recognized in the set of classified sounds (block 830). In response to the classification data indicating the sound is not recognized, the method 800 may include initiating a user alert (block 840).

The method 800 may include determining, based on environment data, whether the classification data indicates the sound is expected for the environment (block 850). In response to the environment data indicating the sound is unexpected, the method 800 may include initiating a premises alert (block 860). In various implementations, the user alert may also or alternatively be initiated in response to the environment data indicating the sound is unexpected. The premises alert and/or the user alert may be initiated by transmitting alert data to a user device. The alert data may indicate the sound is not expected. The method 800 may include receiving, from the user device, identification data (block 870). The identification data may indicate the sound is expected for the environment. The identification data may indicate the sound is expected for the premises. The method 800 may include updating the classification model to recognize the sound as expected (block 880).

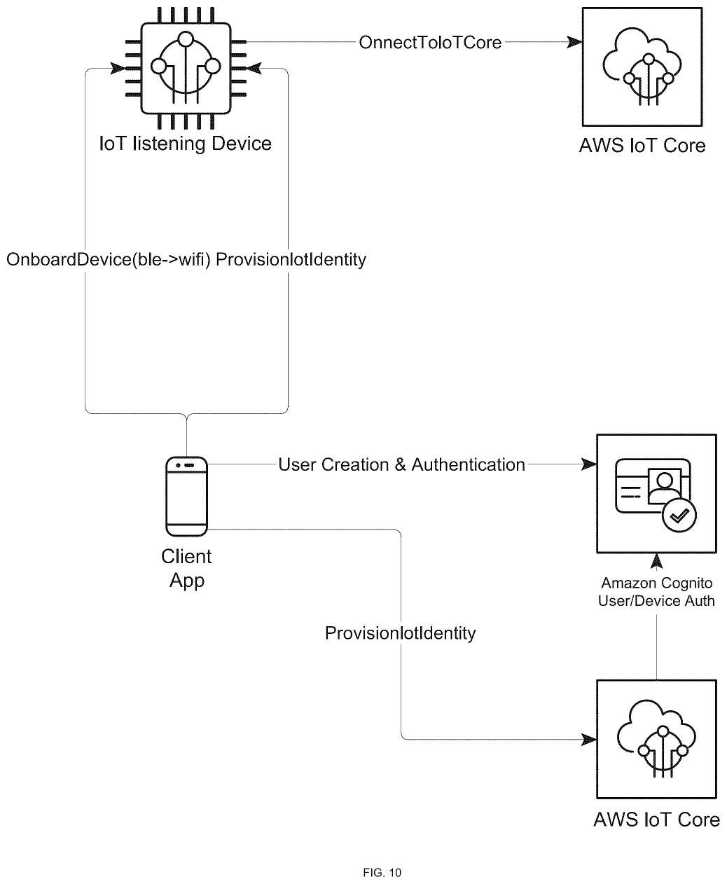

FIG. 9, FIG. 10, and FIG. 11 illustrate an example system architecture of the various systems and methods disclosed herein. The example system architecture may be constructed using various tools of the Amazon Web Services (AWS) suite.

The audio classification service may classify audio input and store the results in a data store. Audio clips that cannot be classified may be flagged for an end user to help identify and label the audio. Such information may be used for re-training the classification model. Once 100 audio clips have been labeled by end users, the model may be re-trained with these results, using a percentage of the audio clips for validation. Audio clips may be persisted in a S3 bucket with a policy that removes the files after 24 hours. This may allow for playback of the audio input file by the user on a mobile device.

A dynamoDB table may be used for mapping classifications to categories. The initial categorization values may be provided. Users may be able to customize which classifications trigger push notification to the mobile application, e.g., “when the device hears a dog barking, send me a push notification.” By default, push notifications may be turned off for all sounds. By default, push notifications may be turned on for all sounds, or for certain sounds. Users may select the sounds for which they want to receive push notifications. Audio clips may have a fixed length, such as a length of 10 seconds, 5 seconds, 15 seconds, etc.

Users may install multiple microphone hardware devices on a single premises (e.g., a home) or on multiple premises (e.g., office, cabin, and their main home). Users may create a friendly name/label for the microphone hardware device. When a user turns off the microphone, either using the physical switch on the hardware device or the button in the mobile app, the backend may store an entry with a timestamp that the device is not listening. When a user turns on the microphone, the backend may store an entry with a timestamp that the device is listening.

The microphone hardware device may have a corresponding microphone sensitivity value associated with it, which may be used to determine if a sound of interest has occurred. Such an occurrence may trigger an audio recording and audio classification. The default microphone sensitivity value may be, for example, 500 RMS (root mean square). The backend may store the microphone sensitivity value, which may be changed by the user in the mobile app. When the value changes by the user, the backend may push the changed value to the microphone hardware device.

The input data to the audio classification service may have the following fields and format: audio clip—variable length audio clip in Waveform Audio File Format (WAV); occurrence—timestamp of the start of the audio clip in milliseconds (UTC); micID—identifier of the recording device that captured this audio clip; userID—identifier of the user for this audio clip; locationID—identifier of the physical location of the recording device. The output of the audio classification service may be in the following example format:

```
type Sound @model {
  id: <unique identifier for this Sound>
  timestamp: <time stamp of classified sound in milliseconds (UTC)>
  audioClipID: <identifier of the audio clip input>
  category: <List of category enum values>
  classification: <list of sound classification and confidence value
  in json format>
}
```

A classified sound may be mapped to the categories defined, for example, in the AudioSet ontology. The AudioSet ontology is a collection of sound events organized in a hierarchy. Unclassified sounds may be categorized in an “unclassified” sound category until they can be classified. Source-ambiguous sounds may be categorized in a source-ambiguous category until the source can be identified. If an audio clip input contains multiple distinct sounds that can be classified, then the output of the audio classification service may be a separate sound data model for the classified sounds. For example, the audio clip may contain two people talking, a dog barking, and a baby crying. For this single audio input, the service may output 3 sound values having the same audioClipID value.

The timestamp value in the sound output may be the UTC timestamp of the audio clip input plus the time of the sound in the clip. For example: input clip timestamp=1695665455000; input clip duration=5 seconds; occurrence of a bird sound after 3.2 seconds; timestamp value in the sound data output=1695665458200;

The data model may be built in a way such that it is extensible and allows for further categories to be added so that future classified audio can use the new categories.

The input audio clip resolution may have a minimum of 16 bit and a maximum of 24 bit. The input audio clip sample rate may have a minimum of 16 kHz and a maximum of 48 KHz.

The user application may employ an authentication service such as Amazon Cognito to authenticate a device. For example, the service may utilize a “Sign On with Apple” or “Sign-in with Google” service. Notifications may be made using one or more of a variety of methods, such as push notification, email, SMS, or other notification approaches. The application may be instrumented with mobile analytics to gather information about the ways in which applications are used, information about the devices used, or other attributes.

The application may include a dashboard that displays a visual representation of the classified and categorized sounds. Sound events may include those that occurred within the past 24 hours, 12 hours, 36 hours, 48 hours, etc. A user may customize the time frame for which to display sound occurrences. Users may play the audio clip for a sound using an embedded audio player within the application. Users may share a selected audio clip with others using a device-native sharing capability.

A user with multiple microphone hardware devices may be prompted to name each device. The name of the device provided by the user may be displayed in on a sound detail page. The application may include an interface that enables users to turn on or off the microphone hardware device. When the microphone is turned off in the mobile app, the device may not capture audio clips or may not send captured clips to the audio classification service.

Clicking on an individual sound may display details about the sound event, such as the date and time it occurred, the classification (i.e. dog barking), the category (i.e. Animal sounds), and/or an option to play the captured audio clip. Clicking on an unclassified sound may display details about the sound event, such as the date and time it occurred and/or an option to play the captured audio clip. The user interface (UI) of the application may prompt the user to submit a label for this sound.

On the first occurrence of an uncategorized sound, a notification may be sent to the user notifying them of an unrecognized sound. The UI for submitting a label for an unclassified sound may present one or more suggestions. Such suggestions may be based on one or more low-confidence scores during audio classification. The UI may include a free-form text option where the user can enter their own label.

The mobile application may display information on when the microphone device audio recording is turned off and/or when it is turned back on again, including the date and time of such occurrences. This may prevent user confusion when no classification events happened during a time period where the microphone device was turned off

The application may display a link to an online store to purchase additional microphone hardware devices.

The user may be able to view and update the microphone sensitivity value for a microphone hardware device. Changes to the microphone sensitivity value may be communicated to the backend of the application, such as by push notification or MQ Telemetry Transport, to be persisted and/or synced with the microphone hardware device. Users may turn off the microphone by physically toggling a switch on the device. When the microphone is turned off via the physical switch or via the button in the application, the device may not send audio clips to the audio classification service.

The hardware device may capture audio recording clips starting from I second prior to a sound occurrence, to send such clips to the audio classification service for classification. The hardware device may calculate the rolling average ambient sound, such as by using a root mean square algorithm, to determine the start time for a sound of interest. The microphone may only submit sounds of interest, rather than all sounds, to the audio classification service. The hardware device may obtain a microphone sensitivity value from the backend service to be used in determining when a sound of interest has occurred. The hardware device may calculate the ambient sound level periodically, such as every I second, and store up to 60 ambient sound level values in device memory.

Average ambient sound may be defined as AS=average (ST0, ST−1, ST−2, ST−3, ST−4), where AS=ambient sound, S=measured sound level (such as in dB), ST0=measured sound level at time now, ST−I=measured sound level at time I second ago, and ST−n=measured sound level at time n seconds ago. The following formula may be used to determine the microphone recording start time for a sound of interest: Sound ofInterest=audio clip from Tstart to Tstart+10 seconds, where Tstart=Tdelta−1, Tdelta=Time if (ST0>(AS+S)), ST0=measured sound level at time now, AS-average (ST0, ST−1, ST−2, ST−3, ST−4) and S=microphone sensitivity value retrieved from the backend of the application.

The audio classification service may be built on AWS using the architecture disclosed herein and depicted in FIGS. 9-11. AWS Cognito may be utilized for authentication. Additionally, “Sign On with Apple” and “Sign-in with Google” may be supported under Cognito. AWS IoTCore may be used for edge device provisioning and communication over AWS simple notification service (“SNS”). Cognito may be utilized for device authentication and security to IoTCore. A NoSQL DB like DynamoDB may be well suited for this service and application. AWS CloudFormation may be utilized to deploy environments. AWS Sagemaker may be utilized for model deployment, serving, and/or updates.

The system may have a variety of success metrics and/or key performance indicators, such as acoustic classification latency, acoustic classification accuracy, acoustic classification precision, recall (sensitivity or true positive rate), F1 score, retrain duration, classification requests per second, service availability, and/or average install time. Acoustic classification latency may refer to the duration of time from an audio clip being received by the audio classification service to a new classification entry persisted in the data store. Acoustic classification accuracy may refer to the proportion of correct predictions out of the total predictions. Acoustic classification precision may refer to the proportion of true positive predictions out of the total positive predictions, where precision=true positives/(true positives+false positives). Recall (sensitivity or true positive rate) may refer to the proportion of true positive predictions out of the total actual positive instances, where recall=true positives/(true positives+false negatives). FI score may be the harmonic mean of precision and recall, which may provide a balance between the two metrics. The metric may be calculated as F1 score=2*((precision*recall)/(precision+recall)). Retrain duration may refer to the amount of time it takes to re-train the model using n annotated (labeled) audio clips, where n may be in a range from 10 audio clips to 1,000 audio clips. In a specific implementation, n may be 100. Such audio clips may have a length in a range from I second to 100 seconds. In a specific implementation, the length may be approximately IO seconds. Classification requests per second may refer to the number of concurrent audio classification requests made to the service per second. Service availability may refer to the uptime requirements for the service. Average install time may refer to the average amount of time it takes to unbox and set up the microphone hardware device for the end user.

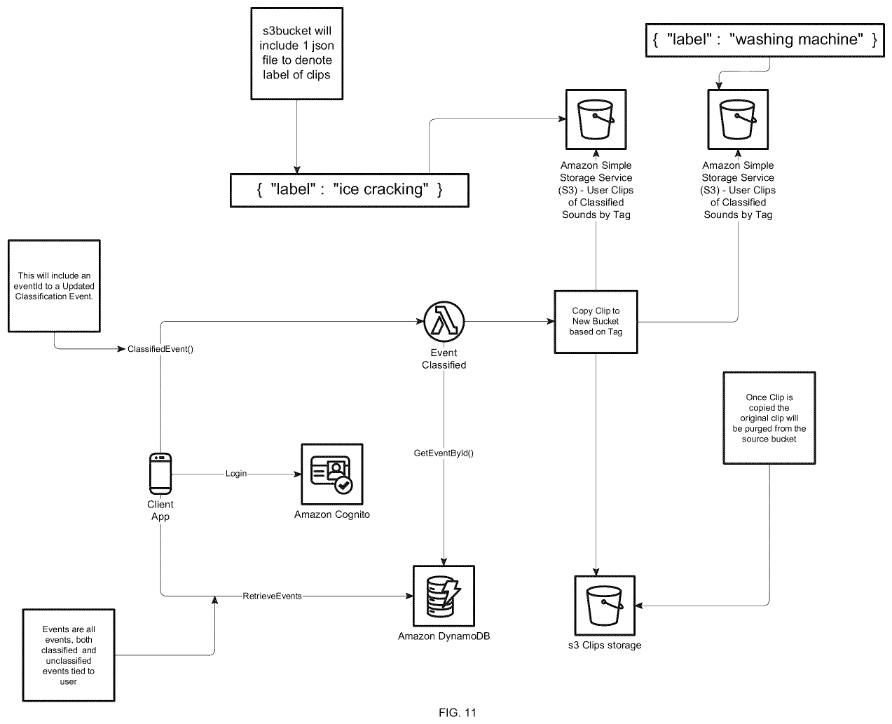

FIG. 12 illustrates a method 1200 of training a sound classification model for a premises monitoring system, according to various implementations. The method 1200 may include receiving audio data corresponding to a sound detected at a premises (block 1202). The audio data may include various information about the sound, such as a device ID for a device that recorded the sound, a time stamp for the sound, a date stamp for the sound, and data representing a sound clip. The method 1200 may include providing the audio data to an active instance of a sound classification model (block 1204). The sound classification model may be trained to recognize a set of sounds. In various implementations, the sound classification model may be trained to correlate a sound with one or more environments in which the sound is expected and/or unexpected.

The method 1200 may include generating, by the active instance of the sound classification model, classification data (block 1206). In various implementations, the classification data may indicate the sound is unrecognized. For example, the classification data may include an empty set or may include a null value for the classification. In some implementations, the classification data may directly indicate the sound as unrecognized, such as by including text such as “unrecognized.”

In response to the classification data indicating the sound is unrecognized, the method 1200 may include providing the audio data associated with the unrecognized sound to a user device associated with a user (block 1208). This may, in various implementations, include generating and transmitting a notification to the user that indicates the sound is unrecognized. The audio data may be automatically transmitted to the user device when it is classified as unrecognized. The audio data may be stored in a data bucket and transmitted to the user device after receiving a request for the audio data from the user device. For example, a user may request the audio data after receiving the notification for the unrecognized sound, the request may be received, and, in response, the audio data may be provided to the user device.

The method 1200 may include receiving, from the user device, updated classification data (block 1210). The updated classification data may indicate an identity of the sound. The updated classification data may indicate one or more environments in which the sound is expected or unexpected. The method 1200 may include storing the audio data and the updated classification data in a data bucket corresponding to the identity of the sound (block 1212).

In various implementations, the method 1200 may include determining the data bucket contains a threshold quantity of user-classified audio data (1214). For example, the threshold may be 100 sound clips corresponding to user-classified audio data. The threshold may be quality-dependent. For example, the user-classified audio data may indicate a confidence level for the identity of the sound. The threshold may be a certain number of sound clips having a minimum confidence level. The confidence level may be set by the user. The confidence level may be set automatically, such as based on a time it takes a user to identify the sound.

The method 1200 may include generating a new instance of the sound classification model (block 1216). In various implementations, the new instance of the sound classification model may be automatically generated in response to determining the data bucket contains a threshold quantity of user-classified audio data. In some implementations, the new instance of the sound classification model may be automatically generated when the sound classification model is made active. For example, a copy of the active instance of the sound classification model may be stored separately from the active instance of the sound classification model.

The method 1200 may include retraining the new instance of the sound classification model using the user-classified audio data (block 1218). The retraining may be accomplished in one or more ways, which may depend on the type of the sound classification model. For example, the sound classification model may be a neural network model with linear classification. The model may be retrained by converting each sound clip in the data bucket into a spectrogram, e.g., a Mel spectrogram, processing each spectrogram through one or more neural network layers, providing the output(s) of the neural network layer(s) to a linear classifier, and outputting a classification prediction. Other retraining methods common in the art and not described herein are also contemplated, which may correspond to the type of model used to classify sound.

In various implementations, the method 1200 may include replacing the active instance of the classification model with the new instance of the sound classification model (block 1220). The new instance of the sound classification model may recognize the previously unrecognized sound when detected.

The method 1200 may, according to some aspects of the present disclosure, be implemented by one or more devices of a premises monitoring system. Such a system may include a listening device, a communication device, and one or more control devices. The listening device may detect a sound and generate audio data based on the sound. The communication device may communicate the audio data from the listening device, e.g., to the control device. The control device may execute one or more functions that, when executed, perform the elements of the method 1200. In various implementations, the system may be implemented in a single unit. For example, the system may be implemented in a monitoring device that includes a microphone, a processor, and one or more communication devices, such as an integrated circuit or printed circuit board, that communicates signals between the microphone and the processor. The processor may have instructions stored thereon that, when executed, perform the elements of the method 1200. In other implementations, the system may include multiple different devices, such as depicted in FIGS. 1, 2, 3, and/or 5.

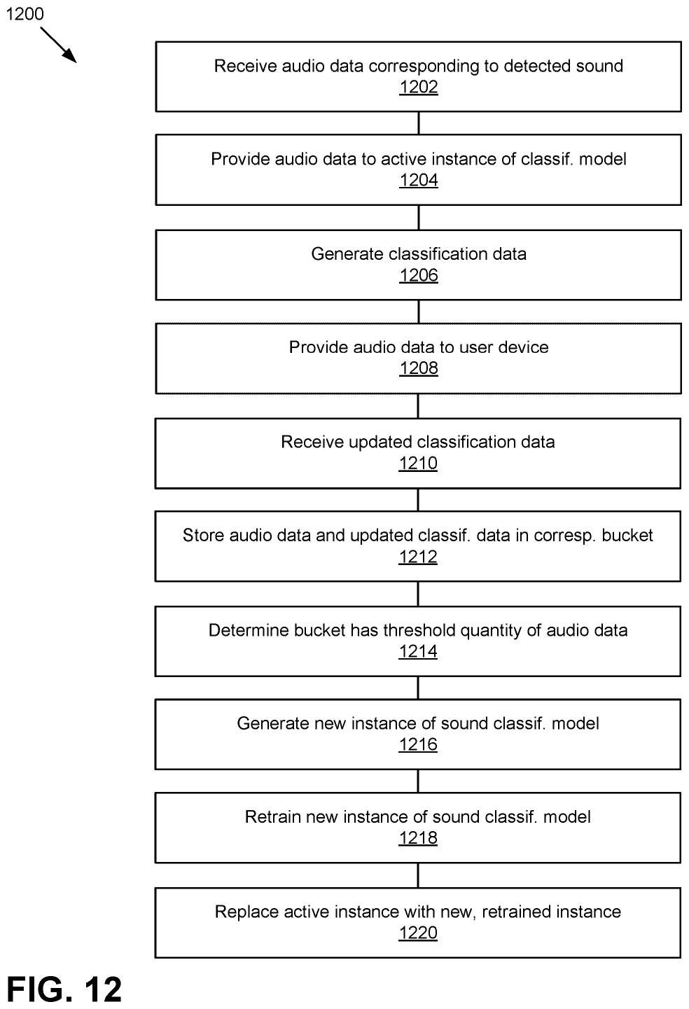

FIG. 13 illustrates a method 1300 of deploying a retrained sound classification model in a premises monitoring system, according to various implementations. The method 1300 may include some or all of the same elements as the method 1200 described above, such as: receiving first audio data corresponding to a first instance of a sound, the first instance of the sound detected at a premises (block 1302); providing the first audio data to an active instance of a sound classification model (block 1304); generating, by the active instance of the sound classification model, first classification data that indicates the sound is unrecognized (block 1306); providing the audio data to a user device associated with a user (block 1308); receiving, from the user device, updated classification data that indicates an identity of the sound (block 1310); storing the first audio data and the updated classification data in a data bucket corresponding to the identity of the sound (block 1312); determining the data bucket contains a threshold quantity of user-classified audio data for the sound (block 1314); generating a new instance of the classification model (block 1316); retraining the new instance of the classification model using the user-classified audio data (block 1318); and/or replacing the active instance of the classification model with the new instance of the classification model (block 1320).

The method 1300 may further include receiving second audio data corresponding to a second instance of the sound (block 1322). The second instance of the sound may be detected after implementation of the new instance of the classification model. The method 1300 may include providing the second audio data to the new instance of the sound classification model (block 1324). Whereas the previously active instance of the sound classification model was unable to recognize the sound, the new instance may be capable of recognizing the sound. The method 1300 may, accordingly, include generating, by the new instance of the sound classification model, second classification data that indicates the identity of the sound (block 1326).

The method 1300 may include determining, based on environment data that identifies expected sounds of an environment associated with the premises, whether the sound is expected for the environment (block 1328). For example, an automatically-executing function may compare the identity of the sound to a database of sounds that are expected and/or unexpected for the environment of the premises. The method 1300 may include initiating a premises alert in response to the environment data indicating the sound is unexpected for the environment (block 1330).

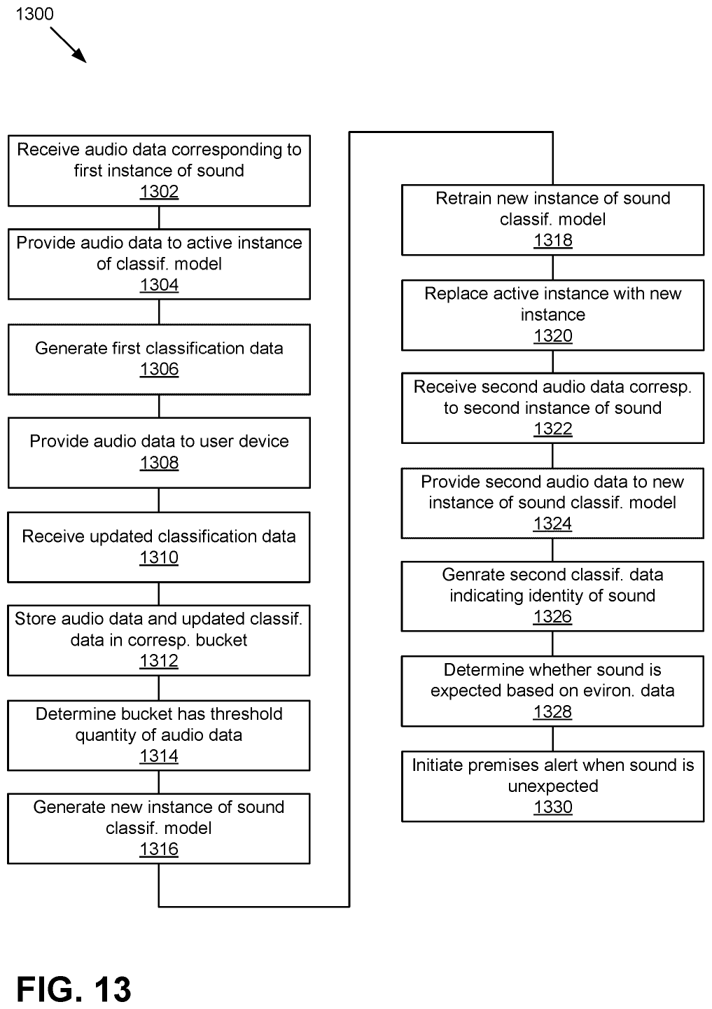

FIG. 14 illustrates a method 1400 of categorizing previously undetected sounds, according to various implementations. The method 1400 may be implemented in connection with other methods described herein, such as the method 1200 and/or the method 1300. For example, elements of the method 1400 may be implemented following receiving updated classification data from a user device. The method 1400 may be implemented by one or more devices of a premises monitoring system, such as those described in detail above. Elements of the method 1400 may, for example, correspond to instructions stored on and/or executed by a control or processing device.

The updated classification data may indicate an identity of the sound for which no data bucket has been created. In various implementations, the method 1400 may include determining the identity of the sound is new (block 1402). For example, a function may automatically execute that compares an identity tag of the updated classification data to identity tags for previously-generated data buckets. In response to the identity tag of the updated classification data not matching any of the identity tags for the previously-generated data buckets, a new data bucket may be generated corresponding to the identity of the sound (block 1404). The audio data and the updated classification data may be stored in the new data bucket (block 1406). In various implementations, the method 1400 may proceed by receiving further audio data, such as by looping back to the beginning of methods 1200 or 1300, until a threshold quantity of audio data is received for the new sound.

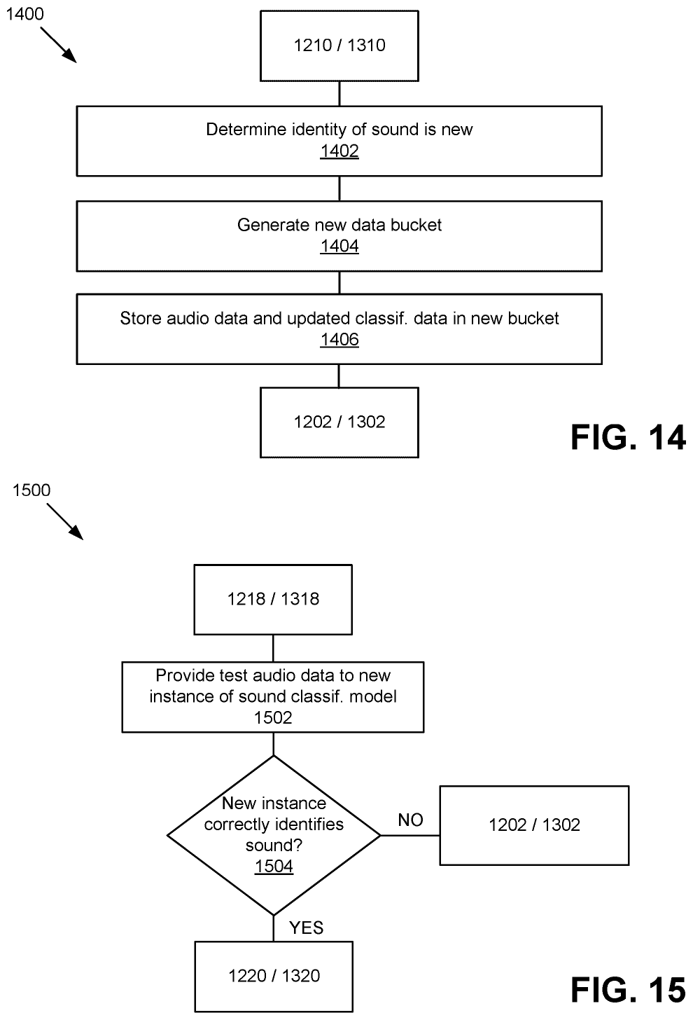

FIG. 15 illustrates a method 1500 of validating an accuracy of a retrained instance of a sound classification model, according to various implementations. The method 1500 may be implemented in connection with other methods described herein, such as the method 1200 and/or the method 1300. For example, elements of the method 1500 may be implemented following generating and/or retraining the new instance of the sound classification model. The method 1500 may be implemented by one or more devices of a premises monitoring system, such as those described in detail above. Elements of the method 1500 may, for example, correspond to instructions stored on and/or executed by a control or processing device.

The method 1500 may include, in various implementations, providing test audio data including the sound to the new instance of the sound classification model (block 1502). The method 1500 may include determining whether the new instance of the sound classification model correctly identifies the sound (block 1504). The active instance of the sound classification model may be replaced with the new instance of the sound classification model in response to the new instance of the sound classification model correctly identifying the sound. In response to the new instance of the sound classification model not correctly identifying the sound, more audio data may be collected for retraining the sound classification model.

In various implementations, the test audio data may include a plurality of sound clips of the sound. The test audio data may include one or more sound clips of the sound and one or more other sounds. Determining whether the new instance of the sound classification model correctly identifies the sound may be based on the new instance correctly identifying a threshold number of the plurality of sound clips. For example, the new instance of the sound classification model may be deployed in the system once it has an accuracy in a range from 95% to 100%, 98% to 100%, 99% to 100%, or 100%.

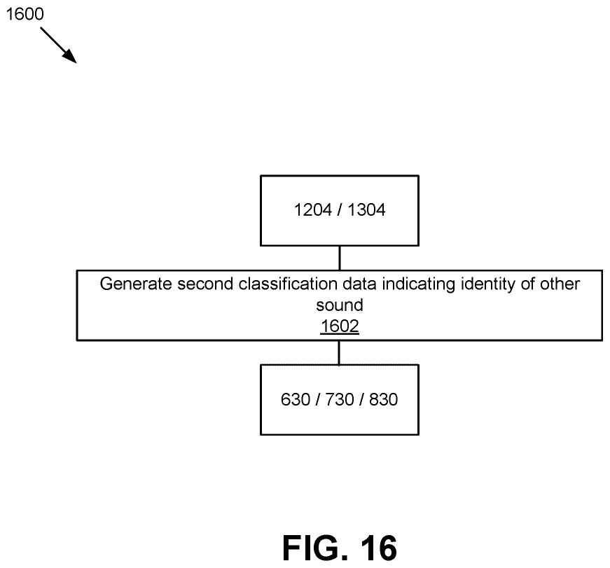

FIG. 16 illustrates a method 1600 of handling audio data that corresponds to multiple sounds, according to various implementations. The method 1600 may be implemented in connection with other methods described herein, such as the method 600, the method 700, the method 800, the method 1200 and/or the method 1300. For example, elements of the method 1600 may be implemented after the received audio data is provided to the active instance of the sound classification model. The method 1600 may be implemented by one or more devices of a premises monitoring system, such as those described in detail above. Elements of the method 1600 may, for example, correspond to instructions stored on and/or executed by a control or processing device.

The audio data may, in some implementations, correspond to two or more sounds. A first sound may not be recognized by the active instance of the sound classification model, and a second sound may be recognized by the active instance of the sound classification model. The method 1600 may, in such implementations, include generating second classification data that indicates an identity of the other sound (block 1602). After determining the identity of the second sound, the second classification data may be used to determine whether the second sound is expected for the environment. For example, environment data for an environment associated with the premises may indicate whether the sound is expected. In response to the environment data indicating the sound is unexpected for the environment associated with the premises, a premises alert may be initiated.

A feature illustrated in one of the figures may be the same as or similar to a feature illustrated in another of the figures. Similarly, a feature described in connection with one of the figures may be the same as or similar to a feature described in connection with another of the figures. The same or similar features may be noted by the same or similar reference characters unless expressly described otherwise. Additionally, the description of a particular figure may refer to a feature not shown in the particular figure. The feature may be illustrated in and/or further described in connection with another figure.

Elements of processes (i.e. methods) described herein may be executed in one or more ways such as by a human, by a processing device, by mechanisms operating automatically or under human control, and so forth. Additionally, although various elements of a process may be depicted in the figures in a particular order, the elements of the process may be performed in one or more different orders without departing from the substance and spirit of the disclosure herein.

The foregoing description sets forth numerous specific details such as examples of specific systems, components, methods and so forth, in order to provide a good understanding of several implementations. It will be apparent to one skilled in the art, however, that at least some implementations may be practiced without these specific details. In other instances, well-known components or methods are not described in detail or are presented in simple block diagram format in order to avoid unnecessarily obscuring the present implementations. The specific details set forth above are merely examples. Particular implementations may vary from these details and still be contemplated to be within the scope of the present implementations.

Related elements in the examples and/or implementations described herein may be identical, similar, or dissimilar in different examples. For the sake of brevity and clarity, related elements may not be redundantly explained. Instead, the use of a same, similar, and/or related element names and/or reference characters may cue the reader that an element with a given name and/or associated reference character may be similar to another related element with the same, similar, and/or related element name and/or reference character in an example explained elsewhere herein. Elements specific to a given example may be described regarding that particular example. A person having ordinary skill in the art will understand that a given element need not be the same and/or similar to the specific portrayal of a related element in any given figure or example in order to share features of the related element.

It is to be understood that the foregoing description is intended to be illustrative and not restrictive. Many other implementations will be apparent to those of skill in the art upon reading and understanding the above description. The scope of the present implementations should, therefore, be determined with reference to the appended claims, along with the full scope of equivalents to which such claims are entitled.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements.

As used herein “same” means sharing all features and “similar” means sharing a substantial number of features or sharing materially important features even if a substantial number of features are not shared. As used herein “may” should be interpreted in a permissive sense and should not be interpreted in an indefinite sense. Additionally, use of “is” regarding examples, elements, and/or features should be interpreted to be definite only regarding a specific example and should not be interpreted as definite regarding every example. Furthermore, references to “the disclosure” and/or “this disclosure” refer to the entirety of the writings of this document and the entirety of the accompanying illustrations, which extends to all the writings of each subsection of this document, including the Title, Background, Brief description of the Drawings, Detailed Description, Claims, Abstract, and any other document and/or resource incorporated herein by reference.

As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or Dis an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or Dis an example that may include: A alone; A and B; A, Band C; A, B, C, and D; and so forth. The bounds of an “and/or” list are defined by the complete set of combinations and permutations for the list.

Where multiples of a particular element are shown in a FIG., and where it is clear that the element is duplicated throughout the FIG., only one label may be provided for the element, despite multiple instances of the element being present in the FIG. Accordingly, other instances in the FIG. of the element having identical or similar structure and/or function may not have been redundantly labeled. A person having ordinary skill in the art will recognize based on the disclosure herein redundant and/or duplicated elements of the same FIG. Despite this, redundant labeling may be included where helpful in clarifying the structure of the depicted examples.

The Applicant(s) reserves the right to submit claims directed to combinations and sub-combinations of the disclosed examples that are believed to be novel and non-obvious. Examples embodied in other combinations and sub-combinations of features, functions, elements and/or properties may be claimed through amendment of those claims or presentation of new claims in the present application or in a related application. Such amended or new claims, whether they are directed to the same example or a different example and whether they are different, broader, narrower or equal in scope to the original claims, are to be considered within the subject matter of the examples described herein.

All patents, published patent applications, and other publications referred to herein are incorporated herein by reference. The invention has been described with reference to various specific and preferred embodiments and techniques. Nevertheless, it is understood that many variations and modifications may be made while remaining within the spirit and scope of the invention.

What is claimed is:

1. A method of training a sound classification model for a premises monitoring system, comprising:
receiving audio data corresponding to a sound detected at a premises; providing the audio data to an active instance of a sound classification model;
generating, by the active instance of the sound classification model, classification data that indicates the sound is unrecognized;
providing the audio data to a user device associated with a user;
receiving, from the user device, updated classification data that indicates an identity of the sound and one or more environments in which the sound is expected or unexpected;
storing the audio data and the updated classification data in a data bucket corresponding to the identity of the sound;
determining the data bucket contains a threshold quantity of user-classified audio data; generating a new instance of the sound classification model;
retraining the new instance of the sound classification model using the user-classified audio data; and
replacing the active instance of the classification model with the new instance of the sound classification model.

2. The method of claim 1, further comprising:
determining the identity of the sound is new;
generating a new data bucket corresponding to the identity of the sound; and
storing the audio data and the updated classification data in the new data bucket.

3. The method of claim 1, further comprising:
providing test audio data comprising the sound to the new instance of the sound classification model; and
determining whether the new instance of the sound classification model correctly identifies the sound, wherein the active instance of the sound classification model is replaced with the new instance of the sound classification model in response to the new instance of the sound classification model correctly identifying the sound.

4. The method of claim 3, wherein:
the test audio data comprises a plurality of sound clips of the sound; and determining whether the new instance of the sound classification model correctly
identifies the sound is based on the new instance correctly identifying a threshold number of the plurality of sound clips.

5. The method of claim 1, wherein the audio data corresponds to the sound and another sound that is recognized by the active instance of the sound classification model, the method further comprising generating second classification data that indicates an identity of the other sound.

6. The method of claim 5, further comprising:
determining, based on environment data that identifies expected sounds of an environment, whether the second classification data indicates the other sound is expected for an environment associated with the premises; and
initiating a premises alert in response to the environment data indicating the sound is unexpected for the environment associated with the premises.

7. The method of claim 1, further comprising generating and transmitting a notification to the user that indicates the sound is unrecognized.

8. A method of training a sound classification model for a premises monitoring system, comprising:
receiving first audio data corresponding to a first instance of a sound, the first instance of the sound detected at a premises;
providing the first audio data to an active instance of a sound classification model;
generating, by the active instance of the sound classification model, first classification
data that indicates the sound is unrecognized;
providing the first audio data to a user device associated with a user;
receiving, from the user device, updated classification data that indicates an identity of the sound;
storing the first audio data and the updated classification data in a data bucket corresponding to the identity of the sound;
determining the data bucket contains a threshold quantity of user-classified audio data for the sound;
generating a new instance of the sound classification model;
retraining the new instance of the sound classification model using the user-classified audio data;
replacing the active instance of the classification model with the new instance of the sound classification model;
receiving second audio data corresponding to a second instance of the sound; providing the second audio data to the new instance of the sound classification model;
generating, by the new instance of the sound classification model, second classification data that indicates the identity of the sound;
determining, based on environment data that identifies expected sounds of an environment associated with the premises, whether the sound is expected for the environment; and
initiating a premises alert in response to the environment data indicating the sound is unexpected for the environment.

9. The method of claim 8, further comprising:
determining the identity of the sound is new;
generating a new data bucket corresponding to the identity of the sound; and
storing the audio data and the updated classification data in the new data bucket.

10. The method of claim 8, further comprising validating an accuracy of the new instance of the sound classification model by:
providing test audio data comprising the sound to the new instance of the sound classification model; and
determining whether the new instance of the sound classification model correctly identifies the sound, wherein the active instance of the sound classification model is replaced with the new instance of the sound classification model in response to the new instance of the sound classification model correctly identifying the sound.

11. The method of claim 10, wherein:
the test audio data comprises a plurality of sound clips of the sound; and determining whether the new instance of the sound classification model correctly
identifies the sound is based on the new instance correctly identifying a threshold number of the plurality of sound clips.

12. The method of claim 8, wherein the first audio data corresponds to the sound and another sound that is recognized by the active instance of the sound classification model, the method further comprising generating second classification data that indicates an identity of the other sound.

13. The method of claim 12, further comprising:
determining, based on the environment data, whether the second classification data indicates the other sound is expected for the environment; and
initiating the premises alert in response to the environment data indicating the sound is unexpected for the environment.

14. The method of claim 8, further comprising generating and transmitting a notification to the user that indicates the sound is unrecognized.

15. A premises monitoring system, comprising:
a listening device that detects a sound and generates audio data based on the sound;
a communication device that communicates the audio data from the listening device; and
one or more control devices that:
receive the audio data;
provide the audio data to an active instance of a sound classification model;
generate, by the active instance of the sound classification model, classification data that indicates the sound is unrecognized;
provide the audio data to a user device associated with a user;
receive, from the user device, updated classification data that indicates an identity of the sound and one or more environments in which the sound is expected or unexpected;
store the audio data and the updated classification data in a data bucket corresponding to the identity of the sound;
determine the data bucket contains a threshold quantity of user-classified audio data;
generate a new instance of the classification model;
retrain the new instance of the classification model using the user-classified audio data; and
replace the active instance of the classification model with the new instance of the classification model.

16. The premises monitoring system of claim 15, wherein the one or more control devices further:
determine the identity of the sound is new;
generate a new data bucket corresponding to the identity of the sound; and store the audio data and the updated classification data in the new data bucket.

17. The premises monitoring system of claim 15, wherein the one or more control devices further:
provide test audio data comprising the sound to the new instance of the sound classification model; and
determine whether the new instance of the sound classification model correctly identifies the sound, wherein the active instance of the sound classification model is replaced with the new instance of the sound classification model in response to the new instance of the sound classification model correctly identifying the sound.

18. The premises monitoring system of claim 17, wherein:
the test audio data comprises a plurality of sound clips of the sound; and determining whether the new instance of the sound classification model correctly
identifies the sound is based on the new instance correctly identifying a threshold number of the plurality of sound clips.

19. The premises monitoring system of claim 15, wherein the audio data corresponds to the sound and another sound that is recognized by the active instance of the sound classification model, and wherein the one or more control devices further generate second classification data that indicates an identity of the other sound.

20. The premises monitoring system of claim 19, wherein the one or more control devices further:
determine, based on environment data that identifies expected sounds of an environment, whether the second classification data indicates the other sound is expected for an environment associated with the premises; and
initiate a premises alert in response to the environment data indicating the sound is unexpected for the environment associated with the premises.
